(19) United States
(12) Patent Application Publication
(10) Pub. No.: US 2020/0075225 A1
(43) Pub. Date: Mar. 5, 2020

(54) MAGNETIC COUPLER AND COMMUNICATION SYSTEM

(71) Applicants: Kabushiki Kaisha Toshiba, Tokyo (JP); Toshiba Electronic Devices & Storage Corporation, Tokyo (JP)

(72) Inventor: Katsuyuki Ikeuchi, Yokohama Kanagawa (JP)

(21) Appl. No.: 16/273,309

(22) Filed: Feb. 12, 2019

(30) Foreign Application Priority Data
Sep. 5, 2018 (JP) 2018-166019

(51) Int. Cl. H01F 27/28; H01F 27/36; H01F 38/14

(52) U.S. Cl. CPC H01F 27/288; H01F 2038/143; H01F 38/14; H01F 27/362

(57) ABSTRACT

According to one embodiment, there is provided a magnetic coupler including a first coil, a second coil and a first electric shield. The second coil faces the first coil. The first electric shield is disposed between the first coil and the second coil and electrically connected to a reference node of a circuit on the first coil side or the second coil side.

### CROSS-REFERENCE TO RELATED APPLICATIONS

This application is based upon and claims the benefit of priority from Japanese Patent Application No. 2018-166019, filed on Sep. 5, 2018; the entire contents of which are incorporated herein by reference.

### FIELD

Embodiments described herein relate generally to a magnetic coupler and a communication system.

### BACKGROUND

A magnetic coupler provided between a transmission circuit and a reception circuit magnetically couples the transmission circuit and the reception circuit while electrically insulating the transmission circuit and the reception circuit from each other. At this time, it is preferable to appropriately transmit signals and/or the electric power from the transmission circuit to the reception circuit through the magnetic coupler.

### BRIEF DESCRIPTION OF THE DRAWINGS

FIG. 1 is a diagram illustrating a circuit configuration of a communication system including a magnetic coupler according to an embodiment;

FIG. 2 is a diagram illustrating a mounting configuration of the magnetic coupler according to the embodiment;

FIGS. 3A to 3C are diagrams illustrating a planar configuration of a shield pattern in the embodiment;

FIG. 4 is a diagram illustrating a circuit configuration of a communication system including a magnetic coupler according to a first modified example of the embodiment;

FIG. 5 is a diagram illustrating a circuit configuration of a communication system including a magnetic coupler according to a second modified example of the embodiment;

FIG. 6 is a diagram illustrating a circuit configuration of a communication system including a magnetic coupler according to a third modified example of the embodiment;

FIG. 7 is a diagram illustrating a circuit configuration of a communication system including a magnetic coupler according to a fourth modified example of the embodiment;

FIG. 8 is a diagram illustrating a circuit configuration of a communication system including a magnetic coupler according to a fifth modified example of the embodiment; and

FIG. 9 is a diagram illustrating a circuit configuration of a communication system including a magnetic coupler according to a sixth modified example of the embodiment.

### DETAILED DESCRIPTION

In general, according to one embodiment, there is provided a magnetic coupler including a first coil, a second coil and a first electric shield. The second coil faces the first coil. The first electric shield is disposed between the first coil and the second coil and electrically connected to a reference node of a circuit on the first coil side or the second coil side.

Exemplary embodiments of a magnetic coupler will be explained below in detail with reference to the accompanying drawings. The present invention is not limited to the following embodiments.

### Embodiment

A magnetic coupler according to an embodiment will be described. For example, in a case where a primary side circuit and a secondary side circuit are greatly different in operating voltage, a magnetic coupler is used in a case where it is desired to transmit signals while electrically insulating the primary side circuit and the secondary side circuit from each other. For example, in a case where the primary side circuit includes a motor and an inverter circuit for driving the motor and the secondary side circuit includes a controller for controlling the inverter circuit, the magnetic coupler is disposed between the primary side circuit and the secondary side circuit, so that it is possible to prevent an inrush current from flowing into the controller when the motor is activated.

In a communication system including the magnetic coupler, a transmission circuit is provided in the primary side circuit, and a reception circuit is provided in the secondary side circuit. The magnetic coupler is disposed between the transmission circuit and the reception circuit, and the coil corresponding to the transmission circuit and the coil corresponding to the reception circuit are electrically insulated from each other and magnetically coupled with each other. In this case, it is preferable that the magnetic coupler appropriately transmits signals and/or electric power from the coil on the transmission side (primary side) to the coil on the reception side (secondary side) while isolating the transmission circuit and the reception circuit.

However, S_{CC21} noise affecting common mode transient immunity (CMTI) may occur. The CMTI is a specification required for a coupler and indicates that malfunction does not occur by inserting a stepped waveform having a slope of 50 kV/us while the coupler is operating. The S_{CC21} indicates the gain of the in-phase noise transmitted to the secondary side of the magnetic coupler in a case where the in-phase noise is applied to the primary side of the magnetic coupler.

For example, if the coil corresponding to the transmission circuit and the coil corresponding to the reception circuit are capacitively coupled via the parasitic capacitance, the GND noise (in-phase noise) on the primary side oscillates a common mode on the secondary side through the parasitic capacitance of the magnetic coupler, and thus, there is possibility that the noise (S_{CC21} noise) by which the reception circuit on the secondary side cannot properly receive the signal occurs. When the S_{CC21} noise occurs, the operating point of the reception circuit tends to deviate from the allowable range. For example, in a case where the allowable range is in the vicinity of the intermediate potential between the ground potential and the power supply voltage, if the operating point of the reception circuit shifts to the power supply voltage side, the signal amplitude sticks to the power supply voltage, and thus, erroneous operation and failure of the reception circuit occur, so that there is possibility that it is difficult to satisfy specifications required for the CMTI.

Therefore, in the present embodiment, in the magnetic coupler, by arranging an electric shield between the coil corresponding to the transmission side and the coil corresponding to the reception side and connecting the electric shield to the ground node of the reception circuit, the operating point of the reception circuit tries to be made appropriate.

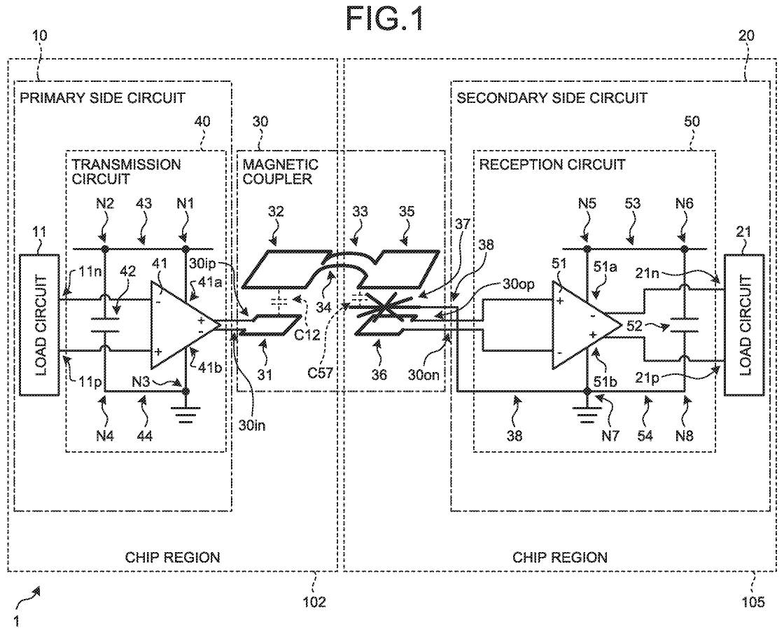

Specifically, a communication system 1 including a magnetic coupler 30 may be configured as illustrated in FIG. 1. FIG. 1 is a diagram illustrating a configuration of the communication system 1 including the magnetic coupler 30.

The communication system 1 includes a primary side circuit 10, a secondary side circuit 20, and the magnetic coupler 30. The magnetic coupler 30 is disposed between the primary side circuit 10 and the secondary side circuit 20. The magnetic coupler 30 can magnetically couple the primary side circuit 10 and the secondary side circuit 20 to each other while electrically insulating the primary side circuit 10 and the secondary side circuit 20 from each other.

The magnetic coupler 30 can be a coupler corresponding to a differential configuration. The magnetic coupler 30 converts the pair of differential signals transmitted from the primary side circuit 10 to magnetic field energy, re-converts the magnetic field energy to a pair of differential signals, and transmits the pair of differential signals to the secondary side circuit 20.

The primary side circuit 10 includes a load circuit 11 and a transmission circuit 40. The secondary side circuit 20 includes a reception circuit 50 and a load circuit 21. The magnetic coupler 30 has a coil corresponding to the transmission side and a coil corresponding to the reception side, and thus, the operating voltage can be transformed with the winding ratio between the two coils. For example, in a case where the operating voltage of the motor is monitored by the controller, the primary side circuit 10 becomes the high voltage region, the secondary side circuit 20 becomes the low voltage region, the load circuit 11 includes the motor and the inverter circuit, and the load circuit 21 includes the controller. For example, in a case where the controller controls the operation of the motor, the primary side circuit 10 becomes the low voltage region, the secondary side circuit 20 becomes the high voltage region, the load circuit 11 includes the controller, and the load circuit 21 includes the motor and the inverter circuit. In any case, each of the load circuit 11, the transmission circuit 40, the reception circuit 50, and the load circuit 21 may be formed as a differential configuration.

The transmission circuit 40 is disposed between the load circuit 11 and the magnetic coupler 30. The transmission circuit 40 includes a differential amplifier 41, a coupling capacitor 42, a power supply line 43, and a ground line 44. The differential amplifier 41 is a differential input/differential output type differential amplifier, the non-inversion input terminal (+) is electrically connected to a P-side node 11p of the load circuit 11, the inversion input terminal (−) is electrically connected to an N-side node 11n of the load circuit 11, the non-inversion output terminal (+) is electrically connected to a P-side input node 30ip of the magnetic coupler 30, and the inversion output terminal (−) is electrically connected to an N-side input node 30in of the magnetic coupler 30. One end of the coupling capacitor 42 is electrically connected to the power supply line 43 through a node N2, and the other end is electrically connected to the ground line 44 through a node N4. In the differential amplifier 41, a power supply terminal 41a is electrically connected to the power supply line 43 through a node N1, and a ground terminal 41b is electrically connected to the ground line 44 and the ground potential through a node N3. Each of the node N3 and the node N4 can be regarded as a reference node on the ground side in the transmission circuit 40.

The reception circuit 50 is disposed between the magnetic coupler 30 and the load circuit 21. The reception circuit 50 includes a differential amplifier 51, a coupling capacitor 52, a power supply line 53, and a ground line 54. The differential amplifier 51 is a differential input/differential output type differential amplifier, the non-inversion input terminal (+) is electrically connected to a P-side output node 30op of the magnetic coupler 30, the inversion input terminal (−) is electrically connected to an N-side output node 30on of the magnetic coupler 30, the non-inversion output terminal (+) is electrically connected to a P-side node 21p of the load circuit 21, and the inversion output terminal (−) is electrically connected to an N-side node 21n of the load circuit 21. One end of the coupling capacitor 52 is electrically connected to the power supply line 53 through a node N6, and the other end is electrically connected to the ground line 54 through a node N8. In the differential amplifier 51, a power supply terminal 51a is electrically connected to the power supply line 53 through a node N5, and a ground terminal 51b is electrically connected to the ground line 54 and the ground potential through a node N7. Each of the node N7 and the node N8 can be regarded as a reference node on the ground side in the reception circuit 50.

The magnetic coupler 30 may be configured as a double insulation type. The magnetic coupler 30 includes a coil 31, a coil 32, bonding wires 33 and 34, a coil 35, a coil 36, an electric shield 37, and a line 38.

The coil 31 is electrically connected to the transmission circuit 40. One end of the coil 31 is electrically connected to the non-inversion output terminal (+) of the differential amplifier 41 through the input node 30ip, and the other end is electrically connected to the inversion output terminal (−) of the differential amplifier 41 through the input node 30in.

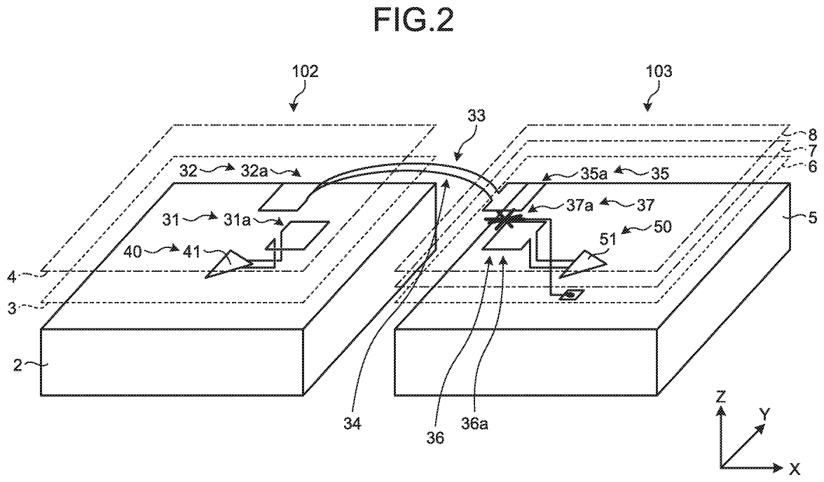

The coil 32 is disposed above the coil 31 and faces the coil 31 through an insulating film (refer to FIG. 2). As a result, the coil 31 and the coil 32 may be electrically insulated from each other and magnetically coupled with each other. In this magnetic coupling, the coil 31 is a coil corresponding to the transmission side, and the coil 32 is a coil corresponding to the reception side. As indicated by a broken line, a parasitic capacitance C12 may be formed between the coil 31 and the coil 32.

Each of the bonding wires 33 and 34 is disposed between the coil 32 and the coil 35 to and electrically connect the coil 32 and the coil 35. One end of the bonding wire 33 is electrically connected to the coil 32, and the other end is electrically connected to the coil 35. One end of the bonding wire 34 is electrically connected to the coil 32, and the other end is electrically connected to the coil 35.

The coil 36 is electrically connected to the reception circuit 50. One end of the coil 36 is electrically connected to the non-inversion output terminal (+) of the differential amplifier 51 through the output node 30op, and the other end is electrically connected to the inversion output terminal (−) of the differential amplifier 41 through the output node 30on.

The coil 35 is disposed above the coil 36 and faces the coil 36 through an insulating film (refer to FIG. 2). As a result, the coil 35 and the coil 36 may be electrically insulated from each other and magnetically coupled with each other. In this magnetic coupling, the coil 35 is a coil corresponding to the transmission side, and the coil 36 is a coil corresponding to the reception side.

The electric shield 37 is disposed between the coil 35 and the coil 36. That is, the electric shield 37 is disposed above the coil 36, faces the coil 36 through an insulating film, is disposed below the coil 35, and faces the coil 35 through an insulating film. The electric shield 37 functions as an electric shield for suppressing formation of a parasitic capacitance between the coil 35 and the coil 36, and is configured so as not to interfere with the magnetic coupling between the coil 35 and the coil 36. As indicated by a broken line, a parasitic capacitance C57 may be formed between the coil 35 and the electric shield 37. In addition, the electric shield 37 is electrically connected to the node N7 of the reception circuit 50 through the line 38.

For example, in a case where the GND noise (in-phase noise) on the primary side is generated in the transmission circuit 40, if the noise is a noise having a frequency component, the noise is transmitted along a path of the transmission circuit 40→the coil 31→the parasitic capacitance C12→the coil 32→the bonding wires 33 and 34→the coil 35→the parasitic capacitance C57→the electric shield 37→the line 38-9 the node N7, is transmitted along a path of the node N7→the ground terminal 51b, and is transmitted along a path of the node N7→the ground line 54→the node N8→the coupling capacitor 52→the node N6→the power supply line 53→the node N5→the power supply terminal 51a. That is, since the noise oscillates the potential of the power supply terminal 51a and the potential of the ground terminal 51b in the differential amplifier 51 in the same manner, the differential amplifier 51 can cancel out the influence of the noise and operate at an appropriate operating point.

In addition, the coils 31 and 32 in the primary side circuit 10 and the magnetic coupler 30 can be included in a chip region 102, and the coil 35, the electric shield 37, and the coil 36 in the secondary side circuit 20 and the magnetic coupler 30 can be included in a chip region 105.

In addition, by adjusting the number of turns of each of the coils 31, 32, 35, and 36 such that the result of multiplying the ratio of the numbers of turns of the coils 31 and 32 and the ratio of the numbers of turns of the coils 35 and 36 becomes VR_{tg}, it is possible to obtain a predetermined transformation ratio VR_{tg} between the primary side circuit 10 and the secondary side circuit 20.

The double insulation type configuration of the magnetic coupler 30 may be mounted as illustrated in, for example, FIG. 2. FIG. 2 is a diagram illustrating a mounting configuration of the magnetic coupler 30. In FIG. 2, a direction perpendicular to the surface of a substrate 2 is defined as a Z direction, and two directions orthogonal to each other in a plane perpendicular to the Z direction are defined as an X direction and a Y direction.

The differential amplifier 41 of the transmission circuit 40 may be mainly disposed on the substrate 2, and the coil 31 electrically connected to the differential amplifier 41 may be configured as a coil pattern 31a included in the wiring layer 3. The wiring layer 3 is disposed in the +Z direction with respect to the substrate 2 and extends in the X and Y directions. The coil pattern 31a extends along a plane corresponding to the wiring layer 3. The coil 32 may be disposed at a position facing the coil 31 and may be configured as a coil pattern 32a included in the wiring layer 4. The wiring layer 4 is disposed in the +Z direction with respect to the wiring layer 3 and extends in the X and Y directions. The coil pattern 32a extends along a plane corresponding to the wiring layer 4.

The differential amplifier 51 of the reception circuit 50 may be mainly disposed on the substrate 5, and the coil 36 electrically connected to the differential amplifier 51 may be configured as a coil pattern 36a included in the wiring layer 6. The wiring layer 6 is disposed in the +Z direction with respect to the substrate 5 and extends in the X and Y directions. The coil pattern 36a extends along a plane corresponding to the wiring layer 6. The coil 35 may be disposed at a position facing the coil 36 and may be configured as a coil pattern 35a included in the wiring layer 8. The wiring layer 8 is disposed in the +Z direction with respect to the wiring layer 7 and extends in the X and Y directions. The coil pattern 35a extends along a plane corresponding to the wiring layer 8. The electric shield 37 may be disposed between the coil 35 and the coil 36 in the Z direction and may be configured as a shield pattern 37a included in the wiring layer 7. The wiring layer 7 is disposed between the wiring layer 6 and the wiring layer 8 in the Z direction and extends in the X and Y directions. The shield pattern 37a extends along a plane corresponding to the wiring layer 7.

By adopting the double insulation type configuration of the magnetic coupler 30, it is possible to easily secure the withstand voltage between the coil 31 and the coil 36. For example, the withstand voltage between the coil 31 and the coil 32 can be secured by disposing an insulating film between the wiring layer 3 and the wiring layer 4 in the Z direction, and the withstand voltage between the coil 35 and the coil 36 can be secured by disposing an insulating film between the wiring layer 8 and the wiring layer 7 in the Z direction.

That is, in a case where it is difficult for one insulating film to satisfy the required withstand voltage (for example, 10 kV) required between the coil connected to the transmission circuit and the coil connected to the reception circuit, the magnetic coupler 30 can satisfy the required withstand voltage by adopting the double insulation type configuration.

In addition, a region including the substrate 2, the wiring layer 3, and the wiring layer 4 corresponds to the chip region 102, and a region including the substrate 5, the wiring layer 6, the wiring layer 7, and the wiring layer 8 corresponds to the chip region 105.

In FIG. 2, each of the coil patterns 31a and 32a is simply illustrated in an annular pattern, but the coil patterns may be formed in an arbitrary pattern as long as the coil patterns face each other so as to be able to be magnetically coupled with each other. For example, each of the coil patterns 31a and 32a may be an annular pattern, a spiral pattern, or a figure-8 shaped pattern. Similarly, each of the coil patterns 35a and 36a may be configured in an arbitrary pattern as long as the coil patterns 35a and 36a can be magnetically coupled with each other so as to face each other. For example, each of the coil patterns 31a and 32a may be an annular pattern, a spiral pattern, or a figure-8 shaped pattern.

On the other hand, the shield pattern 37a can include a line pattern that does not form a closed path and crosses the coil pattern 35a and the coil pattern 36a when viewed from the Z direction. The shield pattern 37a can include a plurality of such line patterns. The shield pattern 37a is disposed with respect to the coil pattern 35a and the coil pattern 36a at a position where the angle of intersecting with the coil pattern 35a and the coil pattern 36a when viewed from the Z direction is a predetermined angle (for example, approximately 45°) or more.

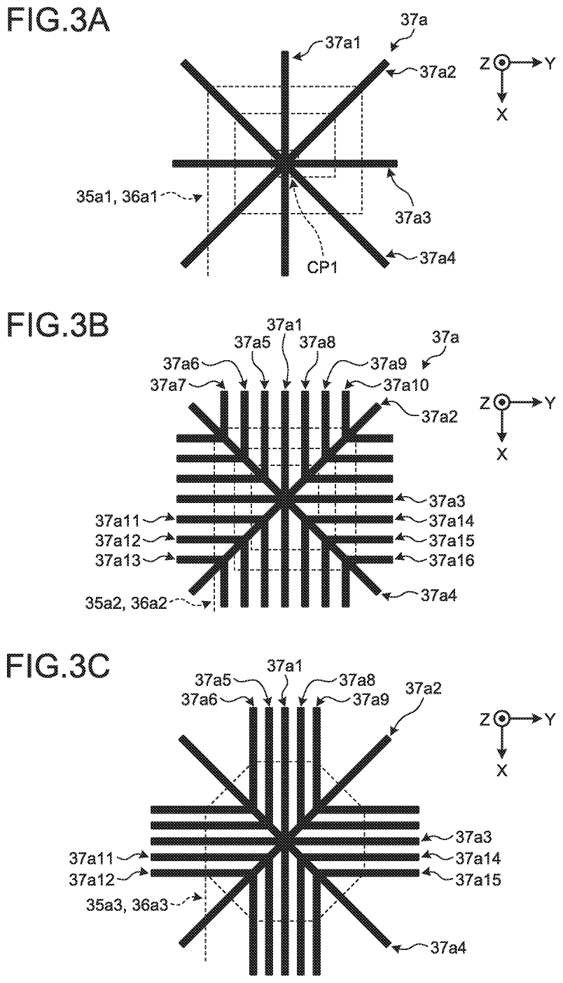

For example, in a case where the coil patterns 35a and 36a are each coil patterns 35a1 and 36al extending in a spiral shape along a substantially rectangular shape as indicated by a wave line in FIG. 3A, the shield pattern 37a can include a plurality of line patterns 37al to 37a4 as indicated by solid lines in FIG. 3A. FIG. 3A is a diagram illustrating an example of a planar configuration of the shield pattern 37a.

The line pattern 37al extends in the +X direction and the −X direction through the vicinity of the center CP1 of the coil pattern 35a1 when viewed from the Z direction. The line pattern 37a2 extends in the oblique direction from the −X and +Y sides to the +X and −Y sides through the vicinity of the center CP1 of the coil pattern 35a1 when viewed from the Z direction. The line pattern 37a3 extends in the −Y direction and the +Y direction through the vicinity of the center CP1 of the coil pattern 35a1 when viewed from the Z direction. The line pattern 37a4 extends in the oblique direction from the −X and −Y sides to the +X and +Y sides through the vicinity of the center CP1 of the coil pattern 35al when viewed from the Z direction.

The plurality of line patterns 37a1 to 37a4 intersects with each other in the vicinity of the center CP1 of the coil pattern 35a1. The plurality of line patterns 37a1 to 37a4 extends so as not to form a closed path. The plurality of line patterns 37a1 to 37a4 can extend radially from the vicinity of the center CP1.

As illustrated in FIG. 3A, each of the line patterns 37a1 to 37a4 can intersect with the coil patterns 35a1 and 36a1 at an angle of 450 or more when viewed from the Z direction. As a result, the electric shield 37 can be configured with the shield pattern 37a which is less likely to magnetically affect the coil patterns 35al and 36a1.

Alternatively, for example, in a case where the coil patterns 35a and 36a are each coil patterns 35a2 and 36a2 extending in a spiral shape along a substantially rectangular shape as indicated by a wave line in FIG. 3B, respectively, the shield pattern 37a can include a plurality of line patterns 37a1 to 37a16 as indicated by solid lines in FIG. 3B. FIG. 3B is a diagram illustrating another example of the planar configuration of the shield pattern 37a.

The line patterns 37a1 to 37a4 are the same as the line patterns 37a1 to 37a4 illustrated in FIG. 3A.

The line pattern 37a5 has a substantially L shape in the XY plane view, intersects at a position shifted from the vicinity of the center of the coil patterns 35a2 and 36a2, and intersects with the −X and −Y side portions of the line pattern 37a4. The line pattern 37a5 extends in the +X direction from the −X side of the line pattern 37a4, intersects with the line pattern 37a4, and extends in the −Y direction.

The line pattern 37a6 has a substantially L shape in the XY plane view, is disposed adjacent to the line pattern 37a5 on the −X and −Y sides, intersects at a position shifted from the vicinity of the center of the coil patterns 35a2 and 36a2, and intersects with the −X and −Y side portions of the line pattern 37a4. The line pattern 37a6 extends in the +X direction from the −X side of the line pattern 37a4, intersects with the line pattern 37a4, and extends in the −Y direction.

The line pattern 37a7 has a substantially L shape in the XY plane view, is disposed adjacent to the line pattern 37a6 on the −X and −Y sides, intersects at a position shifted from the vicinity of the center of the coil patterns 35a2 and 36a2, and intersects with the −X and −Y side portions of the line pattern 37a4. The line pattern 37a7 extends in the +X direction from the −X side of the line pattern 37a4, intersects with the line pattern 37a4, and extends in the −Y direction.

The line pattern 37a8 has a substantially L shape in the XY plane view, intersects at a position shifted from the vicinity of the center of the coil patterns 35a2 and 36a2, and intersects with the −X and +Y side portions of the line pattern 37a2. The line pattern 37a8 extends in the +X direction from the −X side of the line pattern 37a2, intersects with the line pattern 37a2, and extends in the +Y direction.

The line pattern 37a9 has a substantially L shape in the XY plane view, is disposed adjacent to the line pattern 37a5 on the −X and +Y sides, intersects at a position shifted from the vicinity of the center of the coil patterns 35a2 and 36a2, and intersects with the −X and +Y side portions of the line pattern 37a2. The line pattern 37a9 extends in the +X direction from the −X side of the line pattern 37a2, intersects with the line pattern 37a2, and extends in the +Y direction.

The line pattern 37a10 has a substantially L shape in the XY plane view, is disposed adjacent to the line pattern 37a6 on the −X and +Y sides, intersects at a position shifted from the vicinity of the center of the coil patterns 35a2 and 36a2, and intersects with the −X and +Y side portions of the line pattern 37a2. The line pattern 37a10 extends in the +X direction from the −X side of the line pattern 37a2, intersects with the line pattern 37a2, and extends in the +Y direction.

The line pattern 37a11 has a substantially L shape in the XY plane view, intersects at a position shifted from the vicinity of the center of the coil patterns 35a2 and 36a2, and intersects with the +X and −Y side portions of the line pattern 37a2. The line pattern 37a11 extends in the −X direction from the +X side of the line pattern 37a4, intersects with the line pattern 37a2, and extends in the −Y direction.

The line pattern 37a12 has a substantially L shape in the XY plane view, is disposed adjacent to the line pattern 37a5 on the +X and −Y sides, intersects at a position shifted from the vicinity of the center of the coil patterns 35a2 and 36a2, and intersects with the +X and −Y side portions of the line pattern 37a2. The line pattern 37a12 extends in the −X direction from the +X side of the line pattern 37a2, intersects with the line pattern 37a2, and extends in the −Y direction.

The line pattern 37a13 has a substantially L shape in the XY plane view, is disposed adjacent to the line pattern 37a6 on the +X and −Y sides, intersects at a position shifted from the vicinity of the center of the coil patterns 35a2 and 36a2, and intersects with the +X and −Y side portions of the line pattern 37a2. The line pattern 37a13 extends in the −X direction from the +X side of the line pattern 37a2, intersects with the line pattern 37a2, and extends in the −Y direction.

The line pattern 37a14 has a substantially L shape in the XY plane view, intersects at a position shifted from the vicinity of the center of the coil patterns 35a2 and 36a2, and intersects with the +X and +Y side portions of the line pattern 37a4. The line pattern 37a14 extends in the −X direction from the +X side of the line pattern 37a4, intersects with the line pattern 37a4, and extends in the +Y direction.

The line pattern 37a15 has a substantially L shape in the XY plane view, is disposed adjacent to the line pattern 37a5 on the +X and +Y sides, intersects at a position shifted from the vicinity of the center of the coil patterns 35a2 and 36a2, and intersects with the +X and +Y side portions of the line pattern 37a2. The line pattern 37a15 extends in the −X direction from the +X side of the line pattern 37a4, intersects with the line pattern 37a4, and extends in the +Y direction.

The line pattern 37a16 has a substantially L shape in the XY plane view, is disposed adjacent to the line pattern 37a6 on the +X and +Y sides, intersects at a position shifted from the vicinity of the center of the coil patterns 35a2 and 36a2, and intersects with the +X and +Y side portions of the line pattern 37a2. The line pattern 37a16 extends in the −X direction from the +X side of the line pattern 37a4, intersects with the line pattern 37a4, and extends in the +Y direction.

In FIG. 3B, as the winding density of the coil patterns 35a2 and 36a2 is higher than the winding density of the coil patterns 35a1 and 36a1 (refer to FIG. 3A), the arrangement density of the line patterns 37a1 to 37a16 becomes higher than the arrangement density of the line patterns 37a1 to 37a4 (refer to FIG. 3A).

As illustrated in FIG. 3B, each line pattern 37a1 to 37a16 can intersect with the coil patterns 35a2 and 36a2 at an angle of about 45° or more when viewed from the Z direction. As a result, the electric shield 37 may be configured with the shield pattern 37a which is less likely to magnetically affect the coil patterns 35a1 and 36a1.

Alternatively, for example, in a case where the coil patterns 35a and 36a are each coil patterns 35a3 and 36a3 extending in an annular shape along a substantially octagonal shape as indicated by a wave line in FIG. 3C, the shield pattern 37a may include a plurality of line patterns 37a1 to 37a6, 37a8, 37a9, 37a11, 37a12, 37a14, and 37a15 as illustrated by solid lines in FIG. 3C. FIG. 3C is a diagram illustrating another example of the planar configuration of the shield pattern 37a.

The plurality of line patterns 37a1 to 37a15 illustrated in FIG. 3C may be configured by omitting the line patterns 37a7, 37a10, 37a13, and 37a16 from the plurality of line patterns 37al to 37a16 illustrated in FIG. 3B.

As illustrated in FIG. 3C, each line pattern 37a1 to 37a15 can intersect with the coil patterns 35a3 and 36a3 at an angle of about 45° or more when viewed from the Z direction. As a result, the electric shield 37 may be configured with the shield pattern 37a which is less likely to magnetically affect the coil patterns 35a1 and 36a1.

As described above, in the embodiment, in the magnetic coupler 30, the electric shield 37 is disposed between the coil 35 corresponding to the transmission side and the coil 36 corresponding to the reception side, and the electric shield 37 is connected to the node N7 on the ground side of the reception circuit 50. In the reception circuit 50, the node N7 on the ground side is electrically connected to the node N6 on the power supply side through the coupling capacitor 52. As a result, the in-phase noise transmitted from the transmission side can be allowed to oscillate the power supply level and the ground level in the reception circuit 50 in the same manner, so that the operating point of the reception circuit 50 can be made appropriate. As a result, erroneous operation and failure of the reception circuit may be suppressed, and thus, it is easy to satisfy the specifications required for the CMTI.

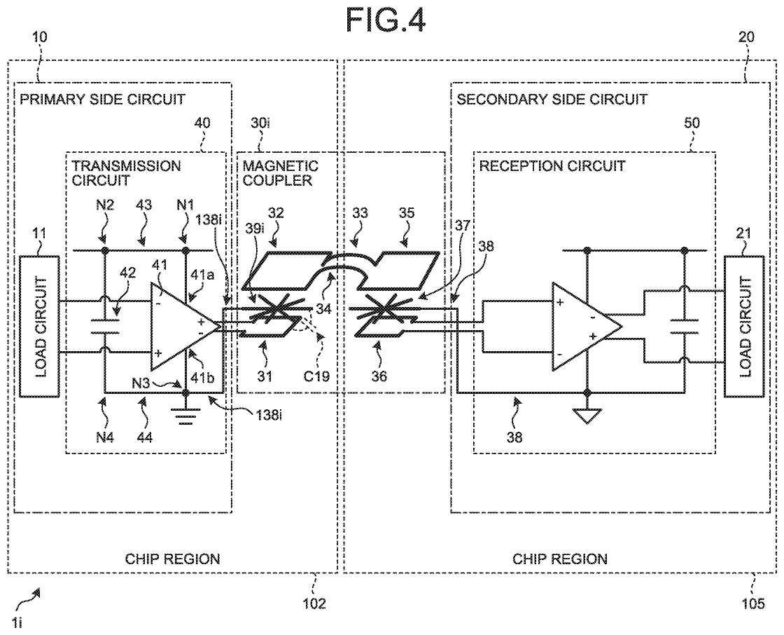

As a first modified example of the embodiment, as illustrated in FIG. 4, a magnetic coupler 30i in a communication system 1i may have a configuration such that electric shields are provided to both the transmission side and the reception side. FIG. 4 is a diagram illustrating a circuit configuration of the communication system 1i including the magnetic coupler 30i according to the first modified example of the embodiment. Specifically, the communication system 1i includes a magnetic coupler 30i in place of the magnetic coupler 30 (refer to FIG. 1). The magnetic coupler 30i further includes an electric shield 39i and a line 138i.

The electric shield 39i is disposed between the coil 31 and the coil 32. That is, the electric shield 39i is disposed above the coil 31, faces the coil 31 through an insulating film, is disposed below the coil 32, and faces the coil 32 through an insulating film. The electric shield 39i functions as an electric shield for suppressing formation of a parasitic capacitance between the coil 31 and the coil 32 and is configured so as not to interfere with the magnetic coupling between the coil 31 and the coil 32. As indicated by the broken line, a parasitic capacitance C19 may be formed between the coil 32 and the electric shield 39i. In addition, the electric shield 39i is electrically connected to the node N3 of the transmission circuit 40 through the line 138i.

For example, in a case where the GND noise (in-phase noise) on the primary side is generated in the transmission circuit 40, if the noise is a noise having a frequency component, the noise is transmitted along a path of the transmission circuit 40→the coil 31→the parasitic capacitance C19→the electric shield 39i→the line 138i→node N3, is transmitted to the node N3→the ground terminal 41b, and is transmitted along a path of the node N3→the ground line 44→the node N4→the coupling capacitor 42→the node N2→the power supply line 43→the node N1→the power supply terminal 41a. That is, since the noise oscillates the potential of the power supply terminal 41a and the potential of the ground terminal 41b in the differential amplifier 41 in the same manner, the differential amplifier 41 can cancel out the influence of the noise and operate at an appropriate operating point.

As described above, according to the first modified example of the embodiment, since the in-phase noise transmitted from the transmission side is returned to the transmission side and the power supply level and the ground level in the transmission circuit 50 may be similarly oscillated, the operating point of the transmission circuit 50 may be made appropriate, and the state in which the operating point of the reception circuit 50 is appropriate can be maintained.

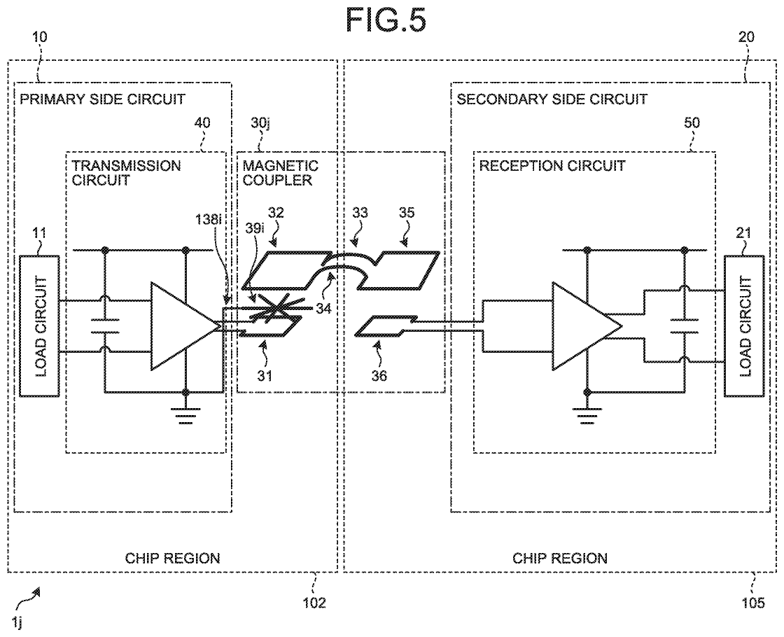

Alternatively, as a second modified example of the embodiment, as illustrated in FIG. 5, a magnetic coupler 30j in a communication system 1j may have a configuration in which the electric shield 37 and the line 38 are omitted from the magnetic coupler 30i (refer to FIG. 4). Even with this configuration, since the in-phase noise transmitted from the transmission side is returned to the transmission side and the power supply level and the ground level in the transmission circuit 50 may be similarly oscillated, the operating point of the transmission circuit 50 can be made appropriate, and the state in which the operating point of the reception circuit 50 is appropriate can be maintained.

Alternatively, in a case where the required withstand voltage (for example, 10 kV) between the coil connected to the transmission circuit and the coil connected to the reception circuit can be satisfied with one insulating film, the magnetic coupler in the communication system may have a single insulation type configuration.

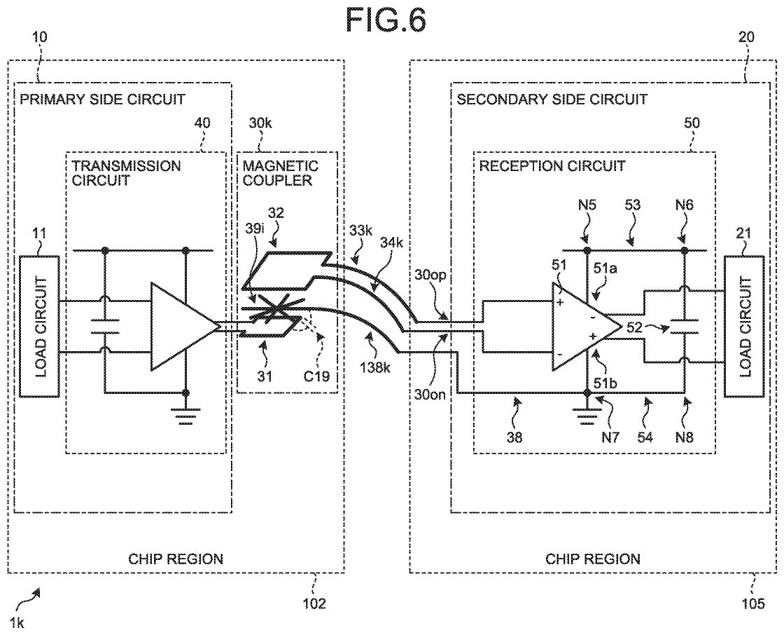

For example, as a third modified example of the embodiment, a magnetic coupler 30k in a communication system 1k may be configured as illustrated in FIG. 6. FIG. 6 is a diagram illustrating a circuit configuration of the communication system 1k including the magnetic coupler 30k according to the third modified example of the embodiment. In the magnetic coupler 30k, the coil 35, the electric shield 37, the line 38 and the coil 36 are omitted from the magnetic coupler 30i (refer to FIG. 4), and bonding wires 33k, 34k, and 138k are provided in place of the bonding wires 33 and 34 and the line 138i (refer to FIG. 4).

Each of the bonding wires 33k and 34k is disposed between the coil 32 and the reception circuit 50 to electrically connect the coil 32 and the reception circuit 50. One end of the bonding wire 33k is electrically connected to the coil 32, and the other end is electrically connected to the non-inversion input terminal (+) of the differential amplifier 51 through the output node 30op. One end of the bonding wire 34k is electrically connected to the coil 32, and the other end is electrically connected to the inversion input terminal (−) of the differential amplifier 41 through the output node 30on.

The bonding wire 138k is disposed between the electric shield 39i and the line 38 to electrically connect the electric shield 39i and the line 38. One end of the bonding wire 138k is electrically connected to the electric shield 39i, and the other end is electrically connected to one end of the line 38.

The electric shield 39i is disposed between the coil 31 and the coil 32. That is, the electric shield 39i is disposed above the coil 31, faces the coil 31 through an insulating film, is disposed below the coil 32, and faces the coil 32 through an insulating film. The electric shield 39i functions as an electric shield for suppressing formation of a parasitic capacitance between the coil 31 and the coil 32 and is configured so as not to interfere with the magnetic coupling between the coil 31 and the coil 32. As indicated by a broken line, the parasitic capacitance C19 may be formed between the coil 32 and the electric shield 39i. The electric shield 39i is electrically connected to the node N7 of the reception circuit 50 through the bonding wire 138k and the line 38.

For example, in a case where the GND noise (in-phase noise) on the primary side is generated in the transmission circuit 40, if the noise is a noise having a frequency component, the noise is transmitted along a path of the transmission circuit 40→the coil 31→the parasitic capacitance C19→the electric shield 39i→the bonding wire 138k→the line 38→the node N7, is transmitted along a path of the node N7→the ground terminal 51b, and is transmitted along a path of the node N7→the ground line 54→the node N8→the coupling capacitor 52→the node N6→the power supply line 53→the node N5→the power supply terminal 51a. That is, since the noise oscillates the potential of the power supply terminal 51a and the potential of the ground terminal 51b in the differential amplifier 51 in the same manner, the differential amplifier 51 can cancel out the influence of the noise and operate at an appropriate operating point.

As described above, according to the third modified example of the embodiment, the in-phase noise transmitted from the transmission side can be allowed to similarly oscillate the power supply level and the ground level in the reception circuit 50, so that the operating point of the reception circuit 50 can be made appropriate.

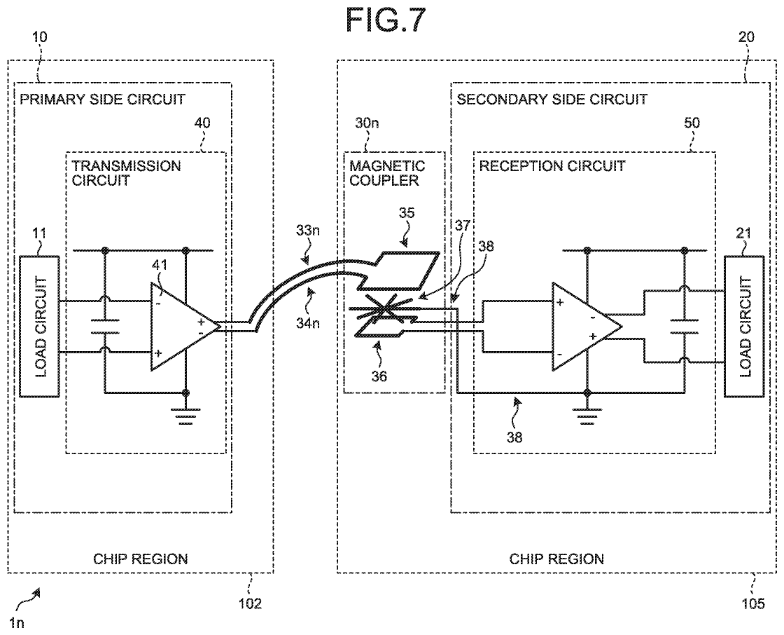

Alternatively, as a fourth modified example of the embodiment, as illustrated in FIG. 7, a magnetic coupler 30n in a communication system in may have a configuration such that the coil 31, the coil 32, the electric shield 39i, and the line 138i are omitted from the magnetic coupler 30i (refer to FIG. 4), and bonding wires 33n and 34n are provided in place of the bonding wires 33 and 34 (refer to FIG. 4).

Each of the bonding wires 33n and 34n is disposed between the transmission circuit 40 and the coil 35 to electrically connect the transmission circuit 40 and the coil 35. One end of the bonding wire 33n is electrically connected to the non-inversion output terminal (+) of the differential amplifier 41, and the other end is electrically connected to the coil 35. One end of the bonding wire 34n is electrically connected to the inversion output terminal (−) of the differential amplifier 41, and the other end is electrically connected to the coil 35.

Even with this configuration, the in-phase noise transmitted from the transmission side can be allowed to oscillate the power supply level and the ground level in the reception circuit 50 in the same manner, so that the operating point of the reception circuit 50 can be made appropriate.

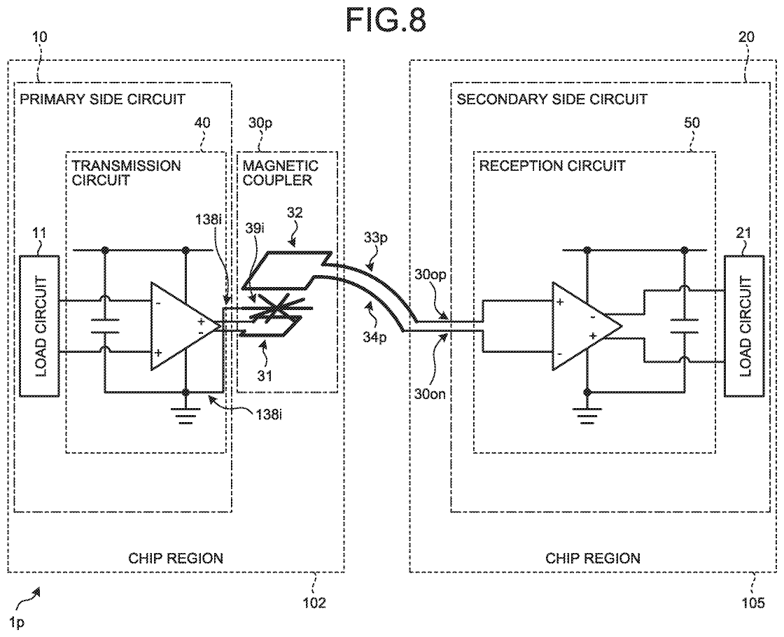

Alternatively, as a fifth modified example of the embodiment, as illustrated in FIG. 8, a magnetic coupler 30p in a communication system 1p may have a configuration such that the coil 35, the coil 36, the electric shield 37, and the line 38 are omitted from the magnetic coupler 30i (refer to FIG. 4) and bonding wires 33p and 34p are provided in place of the bonding wires 33 and 34 (refer to FIG. 4).

Each of the bonding wires 33p and 34p is disposed between the coil 32 and the reception circuit 50 to electrically connect the coil 32 and the reception circuit 50. One end of the bonding wire 33p is electrically connected to the coil 32, and the other end is electrically connected to the non-inversion output terminal (+) of the differential amplifier 51. One end of the bonding wire 34p is electrically connected to the coil 32, and the other end is electrically connected to the inversion output terminal (−) of the differential amplifier 51.

Even with this configuration, the in-phase noise transmitted from the transmission side can be allowed to oscillate the power supply level and the ground level in the reception circuit 50 in the same manner, so that the operating point of the reception circuit 50 can be made appropriate.

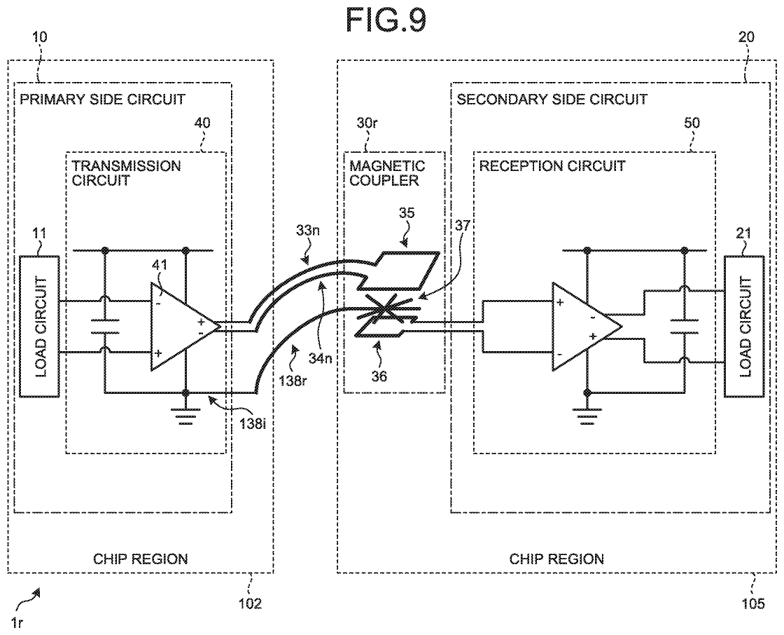

Alternatively, as a sixth modified example of the embodiment, as illustrated in FIG. 9, a magnetic coupler 30r in a communication system 1r may have a configuration such that the coil 31, the coil 32, the electric shield 39i, and the line 38 are omitted from the magnetic coupler 30i (refer to FIG. 4), bonding wires 33n and 34n are provided in place of the bonding wires 33 and 34 (refer to FIG. 4), and a bonding wire 138r is further provided.

Each of the bonding wires 33n and 34n is disposed between the transmission circuit 40 and the coil 35 to electrically connect the transmission circuit 40 and the coil 35. One end of the bonding wire 33n is electrically connected to the non-inversion output terminal (+) of the differential amplifier 41, and the other end is electrically connected to the coil 35. One end of the bonding wire 34n is electrically connected to the inversion output terminal (−) of the differential amplifier 41, and the other end is electrically connected to the coil 35.

The bonding wire 138r is disposed between the electric shield 37 and the line 138i to electrically connect the electric shield 37 and the line 138i. One end of the bonding wire 138r is electrically connected to the electric shield 37, and the other end is electrically connected to one end of the line 138i.

Even with this configuration, since the in-phase noise transmitted from the transmission side is returned to the transmission side and the power supply level and the ground level in the transmission circuit 50 can be similarly oscillated, the operating point of the transmission circuit 50 can be made appropriate, and the state in which the operating point of the reception circuit 50 is appropriate can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic coupler, comprising:
a first coil;
a second coil facing the first coil; and
a first electric shield disposed between the first coil and the second coil and electrically connected to a reference node of a circuit on a side of the first coil or on a side of the second coil side.

2. The magnetic coupler according to claim 1, wherein
in the circuit, the reference node is electrically connected to a power supply node through a coupling capacitor.

3. The magnetic coupler according to claim 1, wherein
the first electric shield has a first line pattern not forming a closed path.

4. The magnetic coupler according to claim 3,
wherein the first coil has a first coil pattern,
wherein the second coil has a second coil pattern corresponding to the first coil pattern, and
wherein the first line pattern intersects with the first coil pattern and the second coil pattern when viewed from a direction from the first coil pattern toward the second coil pattern.

5. The magnetic coupler according to claim 4, wherein
the first line pattern intersects with the first coil pattern and the second coil pattern at an angle of a predetermined degree or more when viewed from the direction.

6. The magnetic coupler according to claim 4,
wherein the first coil pattern extends along a first plane,
wherein the second coil pattern extends along a second plane spaced in the direction with respect to the first plane, and
wherein the first line pattern extends along a third plane between the first plane and the second plane.

7. The magnetic coupler according to claim 3, wherein
the first electric shield further includes a second line pattern intersecting with the first line pattern and not forming a closed path when viewed from a direction from the first coil pattern toward the second coil pattern.

8. The magnetic coupler according to claim 7, wherein
the second line pattern intersects with the first coil pattern and the second coil pattern at an angle of a predetermined degree or more when viewed from the direction.

9. The magnetic coupler according to claim 8, wherein
the first line pattern and the second line pattern intersect with each other in a vicinity of a center of the first coil pattern when viewed from the direction.

10. The magnetic coupler according to claim 7, wherein
the first electric shield further includes a third line pattern intersecting with the first line pattern and the second line pattern and not forming a closed path when viewed from a direction from the first coil pattern toward the second coil pattern.

11. The magnetic coupler according to claim 10,
wherein the first line pattern and the second line pattern intersect with each other in a vicinity of a center of the first coil pattern when viewed from the direction, and
wherein the first line pattern and the third line pattern intersect with each other at a position shifted from the vicinity of the center of the first coil pattern when viewed from the direction.

12. The magnetic coupler according to claim 10, wherein
the third line pattern has a substantially L shape when viewed from the direction.

13. The magnetic coupler according to claim 1,
wherein the circuit includes a first circuit to which the first coil is electrically connected, and
wherein the first electric shield is electrically connected to a reference node of the first circuit.

14. The magnetic coupler according to claim 1,
wherein the circuit includes:
a first circuit to which the first coil is electrically connected; and
a second circuit to which the fourth coil is electrically connected,
wherein the magnetic coupler further comprises:
a third coil electrically connected to the second coil; and
a fourth coil facing the third coil, and
wherein the first electric shield is electrically connected to a reference node of the second circuit.

15. The magnetic coupler according to claim 1,
wherein the circuit includes:
a first circuit to which the first coil is electrically connected; and
a second circuit to which the fourth coil is electrically connected,
wherein the magnetic coupler further comprises:
a third coil electrically connected to the second coil;
a fourth coil facing the third coil; and
a second electric shield electrically connected to a reference node of the second circuit, and
wherein the first electric shield is electrically connected to a reference node of the first circuit.

16. The magnetic coupler according to claim 13, wherein
the first circuit is a transmission circuit.

17. The magnetic coupler according to claim 13, wherein
the first circuit is a reception circuit.

18. The magnetic coupler according to claim 14,
wherein the first circuit is a transmission circuit, and
wherein the second circuit is a reception circuit.

19. The magnetic coupler according to claim 14,
wherein the first circuit is a reception circuit, and
wherein the second circuit is a transmission circuit.

20. A communication system, comprising:
a transmission circuit;
a reception circuit; and
the magnetic coupler according to claim 1 disposed between the transmission circuit and the reception circuit.
